(19) United States
(12) Patent Application Publication
(10) Pub. No.: US 2004/0231471 A1
(43) Pub. Date: Nov. 25, 2004

(54) Enhanced driver for screws and the like/leverage driver

(76) Inventor: Janis Rottkamp, Calverton, NY (US)

Correspondence Address: Attention Thomas A. O'Rourke, Bodner & O'Rourke, LLP, 425 Broadhollow Road, Melville, NY, 11747, US

(21) Appl. No.: 10/719,653

(22) Filed: Nov. 21, 2003

Related U.S. Application Data
(60) Provisional application No. 60/471,504, filed on May 19, 2003.

(51) Int. Cl. B25B 23/16

(52) U.S. Cl. 81/177.5

(57) ABSTRACT

The present invention is an improved driver with an attached pivoting lever that provides additional torque for tightening and loosening connecting means such as screws, nuts and the like.

This Application claims Priority from the U.S. Provisional Application No. 60/471,504 Filed on May 19, 2003.

### FIELD OF THE INVENTION

The present invention is directed to improved screwdrivers and other driving tools including but not limited to nut drivers and socket turning implements.

### BACKGROUND OF THE INVENTION

The present invention is a response to a problem that exists when the user of a driver needs additional torque to loosen or tighten a screw, nut or other device. In many applications the mechanic or craftsman uses a driver to turn a variety of devices. These devices can be slot head screws, Phillips head screws, torx headed screws and others. Drivers are also used to turn nuts and sockets of varying sizes and configurations. It is not uncommon for a screw or other device to become so tightly secured in the wood, metal or plastic that the mechanic is unable to remove the screw with an ordinary driver. In these instances the mechanic will attempt to remove the screw or nut by attaching a pair of pliers, Vise-Grips or other apparatus to provide some additional torque to assist in removing the screw. One of the problems in using these devices is that the mechanic has to leave his or her position and search for the appropriate tool to assist in the removal. This is time consuming and annoying to the user. The present invention relates to an improved driver with a folding lever that is pivotally attached to a side of the driver and which allows for the manual application of extra torque.

Another object of the invention is to provide a variety of hand held tools additional power to tighten, loosen, insert or remove other tools or connecting means.

Furthermore, the present invention allows for a hand held tool to be adjusted simply and economically.

### BRIEF SUMMARY OF THE INVENTION

The present invention is directed to an improved driver having a driving means or pivotable lever that is pivotally attached to the screwdriver. The screwdriver with the attached plastic or metal lever allows for more torque or force to be applied to the driver as it is rotated and thus more force is applied to the connecting means that is either being loosened, tightened or otherwise being manipulated. The lever is preferably made from a metal or strong plastic and can be connected to the screwdriver at various points along the screwdriver. For example, the handle may be secured to the stem of the driver or to the head thereof. The attachment method can vary depending on which part of the screwdriver the metal handle is attached to. In one embodiment the means of attachment can be a hinged mechanism in which the plastic or metal lever pivots perpendicular to the driver.

The present invention also considers the use of different types of joints for attachment of the lever to the hand-held tool. One type of joint other then the pivot joint, is a ball joint which attaches the arm to the hand-held tool and allows for the arm to have free movement to provide more strength. Furthermore, the joint can also encompass a ball joint with a pivot joint to allow the arm to extend perpendicular to the handle of the hand-held tool.

In one specific embodiment of the present invention the pivotal lever is attached to the handle of the driver at a pivot joint and swings out so that it is generally perpendicular, at an angle of about 90 degrees to the driver when in use. The lever preferably fits in a recessed portion provided in the handle when not in use.

The present invention also includes other embodiments which contemplates the use of a variety of hand-held tools that the pivotal lever is attached, to provide extra torque for tightening and loosening. Some examples of other hand-held tools are ratchets, wrenches, a socket wrench, a nut driver, Philips Head screwdriver, slotted screwdriver, torx driver etc.

The primary object of this invention is to provide an attached lever to manual tools in order to apply more torque to the tools while tightening or loosening screws, nuts, bolts and such.

### BRIEF DESCRIPTION OF THE DRAWINGS

FIG. 1 is a bottom view of the handle of the screwdriver showing the pivot joint at which the metal lever is attached.

FIG. 2 is a side view of the handle of the screwdriver with the plastic or metal lever attached at a pivot joint in the recessed position.

FIG. 3 is a view of the top of the screwdriver with the plastic or metal lever in the recessed position.

FIG. 4 is a side perspective of the invention, showing the entire invention with the plastic or metal lever in the extended position.

FIG. 5 is another embodiment of the invention.

FIG. 6 is a top view of the lever in its alternative embodiment.

FIG. 6A is side view of the lever, showing the point of attachment to the handle.

FIG. 6 B is a bottom view of the lever.

FIG. 6 C is a cut away view of the lever.

FIG. 7 is a view of the invention in the closed position.

FIG. 7A is a view of the invention in the open position.

FIG. 7B is a view of the invention in packaging in the closed position.

FIG. 8 is a side perspective of the present invention, showing an alternative embodiment.

FIG. 8A is a detailed view of the alternative embodiment.

FIG. 9 is a side perspective of the present invention, showing an alternative embodiment.

### DETAILED DESCRIPTION OF INVENTION

The improved driver according to the present invention can be best understood and explained by reference to the drawings. The- following figures illustrate one preferred embodiment of the improved screwdriver according to the present invention other embodiments are readily understood from the accompanying description.

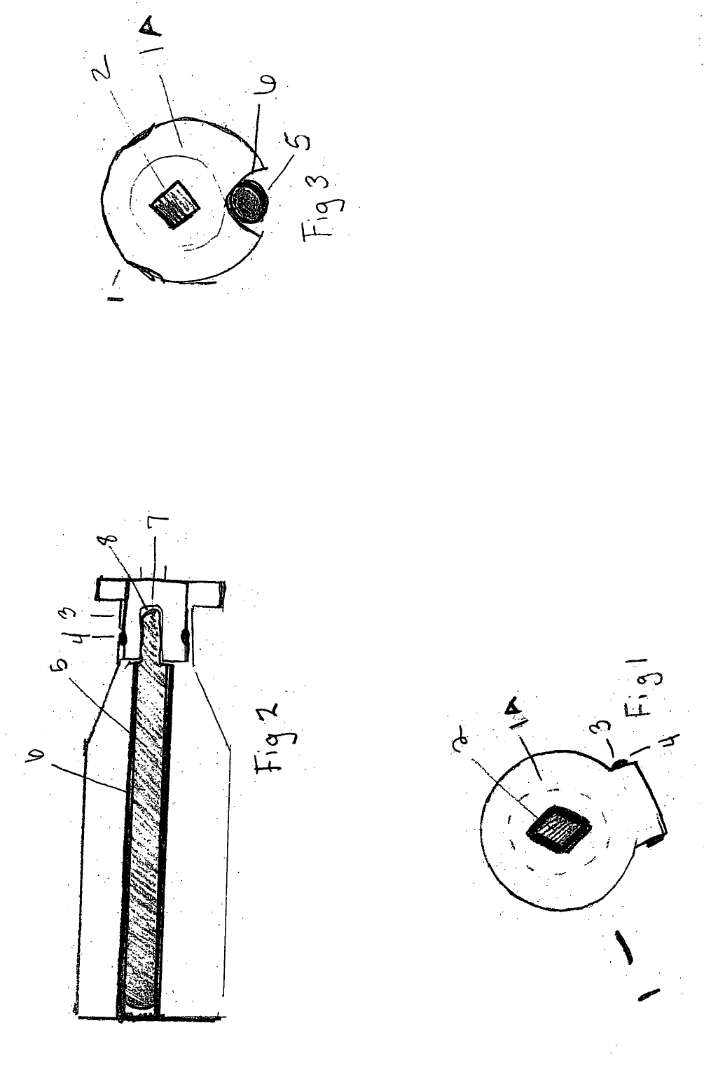

As illustrated in FIG. 1 the driver 1 typically has a handle 1A and a shaft 2. The handle generally is made of a wood or plastic material and is larger in diameter or cross section than the shaft. This provides the user with a comfortable gripping area for use. In addition, the handle should be made from a material that is able to withstand blows from a hammer and the like. The shaft of the driver is preferably a metal rod and can be any suitable configuration in cross section including round, square, hexagon, etc. The shaft of the driver is available in different sizes or diameters such as ¼″, 5/16″, ⅜″ etc. The top of the shaft is preferably flush with the top of the handle of the driver. The tip of the driver is preferably configured with an appropriate configuration for the use of the driver. For example, the tip can have an arrangement for having a ratchet, wrench, a socket, a nut driver, Philips head screwdriver, slotted screwdriver, torx driver etc.

In a preferred embodiment, the shaft 2 of the driver is provided with an arm or lever that is secured to the handle by means of for example, a pivot joint 3 which permits the lever to pivot on a pin 4. The arm or lever 5 is preferably circular in cross section although other configurations are possible. The portion of the lever that is connected to the pivot means the lever has a tongue 8 that is provided with an orifice to permit the lever to be secured to the handle of the driver.

In a preferred embodiment, the driver handle 1A is modified so that the lever 4 can be in the closed position and lay in a groove or recess 6 present in the handle so that it does not interfere with the regular use of the driver. When additional torque is needed, the user pivots the lever into a position about 90 degrees from the driver and the user can use the lever to provide additional torque for operating the driver.

FIG. 2 illustrates a side view of the present invention. The driver 1 and the driver handle 1A are lying horizontal so that the entire length of the lever 5 can be seen in its recessed position laying in the groove 6. The groove 6 is of sufficient length to allow the lever 5 when in the recessed position to not extend above the upper surface of the handle 1A of the driver. Also the recessed groove 6 is of sufficient depth to receive the plastic or metal lever 5 so that it can be comfortably positioned in the head so as not to interfere with the use of the driver when the arm or lever 5 is not required. The recessed groove 6 can also incorporate a magnet to keep the lever 5 in place. The arm or lever 5 is attached to the driver handle at a pivot joint 3 created by a projection on the bottom of the handle that allows for a recess in the projection 7 that enables the arm or lever 5 to be inserted into the recess 8 of the projection 7 and attached by a pin 4 so that the plastic or metal lever 5 pivots out from the driver handle 1A.

FIG. 3 illustrates the top of the screwdriver handle 1A, and displays the shaft part of the screwdriver 2 and also illustrates the grooved or recessed portion of the screwdriver handle 6 with the metal lever 5 in the recessed position.

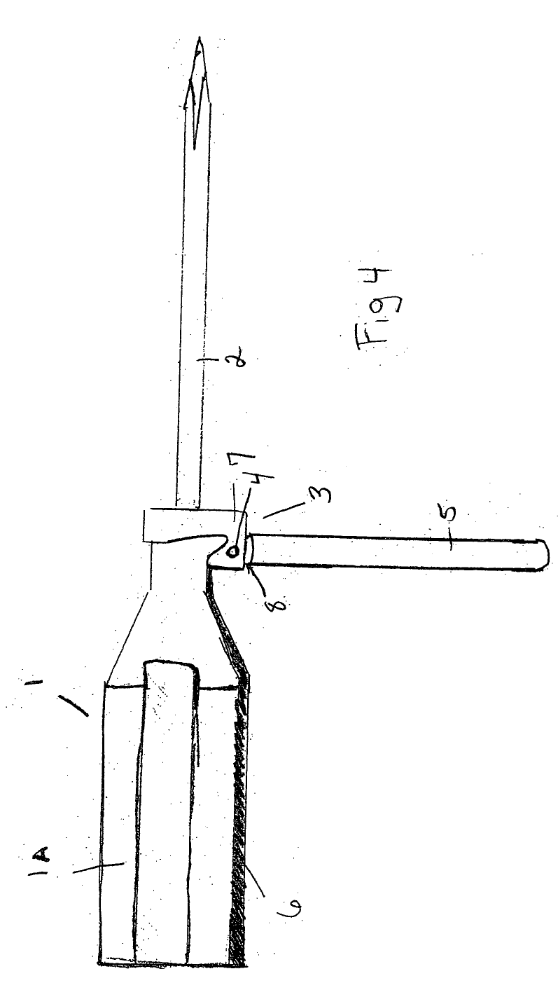

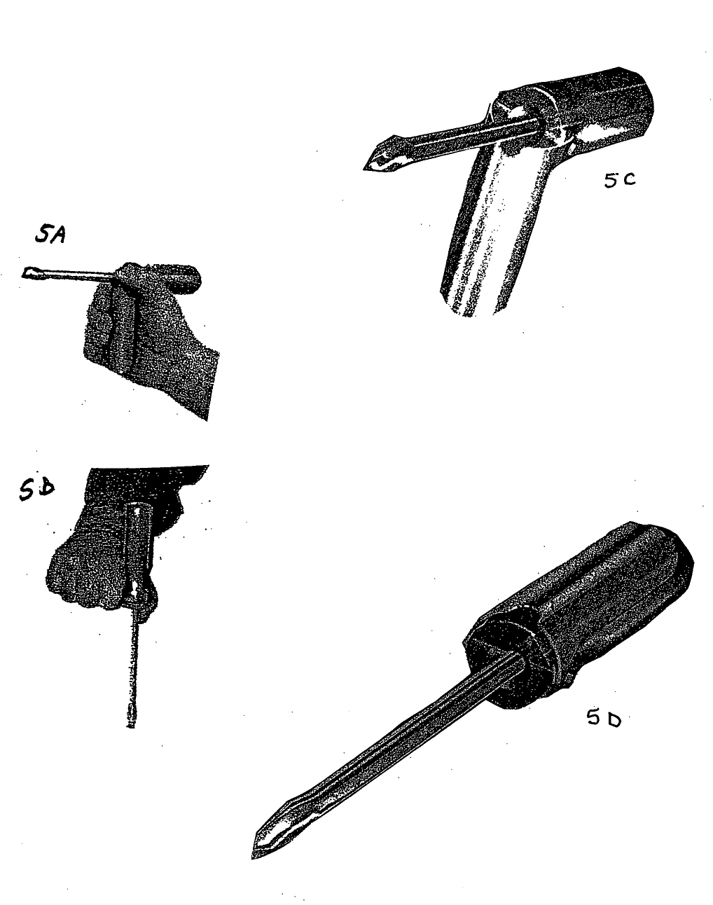

FIG. 4 is a side perspective of the present invention illustrating the plastic or metal handle 5 in the extended position ready to be used along with the screwdriver 2. Also, in this perspective a pivot joint 3 is used with a pin 4 to attach the plastic or metal lever to the recess 8 in the projection 7 of the screwdriver handle 1A.

FIGS. 1-4 illustrate one specific embodiment of the screwdriver according to the present invention. FIG. 4 displays the present invention in the extended position ready to be put to work. In the extended position as FIG. 4 illustrates the arm or lever 5 is perpendicular to the driver 1. The arm or lever 5 is capable of extending to a generally right angle by being attached to the driver handle 1A with a pivot joint 3. The means to attach the metal lever 5 may vary and include attachment means of those such as a ball joint, or a combination of a ball joint and a pivot joint, hinge, clamp, u-bolt or a welded tab with the lever attached with a pin.

The purpose of the metal lever 5 is to provide extra torque or strength to loosen tight screws that have been either warped or rusted, and securing screws. The use of this lever also eases the strain to the wrist of the user preventing injury. However, in order to keep the original integrity of the screwdriver, a recessed groove 6 is carved out of the screwdriver handle 1A to enable the metal or plastic lever 5 to be concealed and not be in the way for regular use of the screwdriver. The recessed groove 6 can also be modified to include a magnet that would hold the metal lever 5 in place.

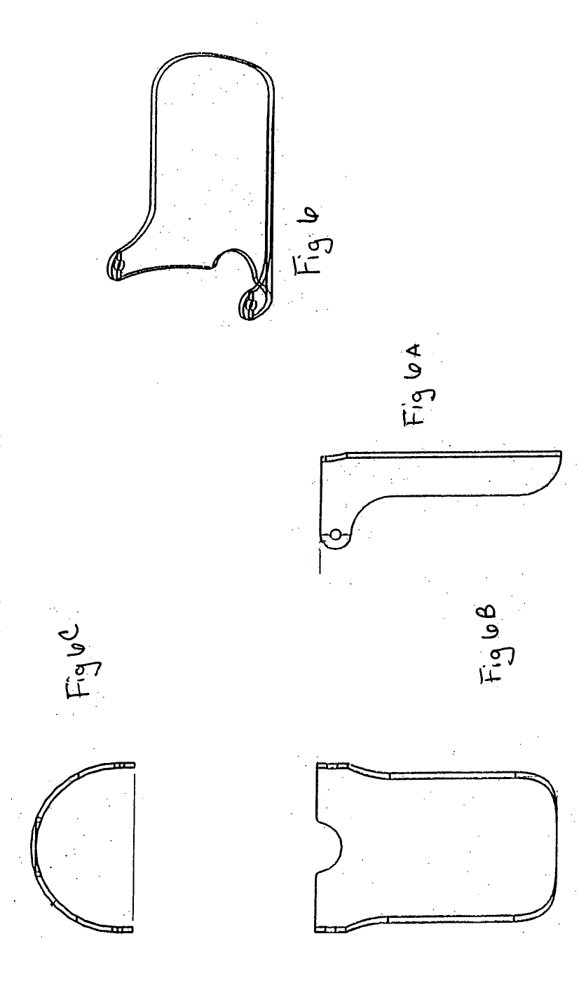

FIG. 5 is another embodiment of the invention that shows the driver 1 in the open and closed position. In the views of FIGS. 5A and 5B the invention can been seen in use. The lever 5 is modified to be wider and curved so that it fits around the handle 1A not into a groove of the handle.

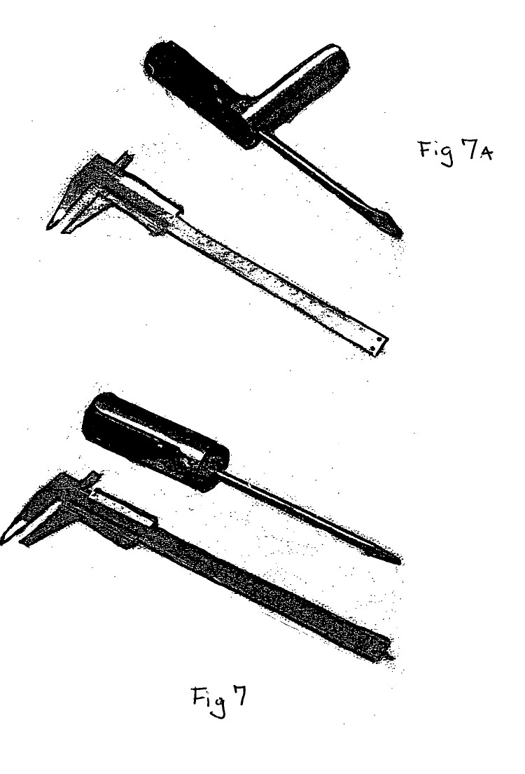

FIG. 6 is a top view of the lever in its alternative embodiment. In this embodiment the lever 5 is wider and is curved so that it can extend outward when in the open position but when in the closed position the lever 5 is convex so that it fits over the handle 1A without hindering the operation of the tool. FIG. 6A is side view of the lever, showing the point of attachment 4 to the handle 1A. FIG. 6 B is a bottom view of the lever. FIG. 6 C is a cut away view of the lever 5 displaying its convex quality.

In FIG. 7 a view of the invention in the alternative embodiment shown in the closed position. FIG. 7A is a view of the invention in the open position with the lever 5 extended in about a 90 degree angle from the handle 1A. FIG. 7B is a view of the invention in packaging in the closed position.

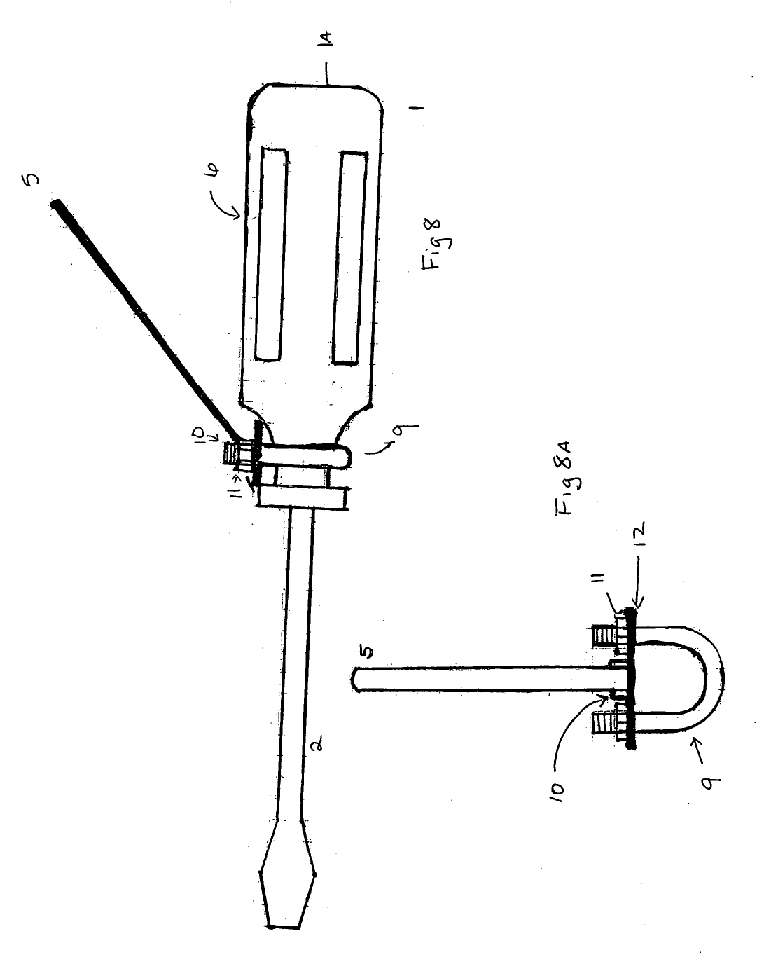

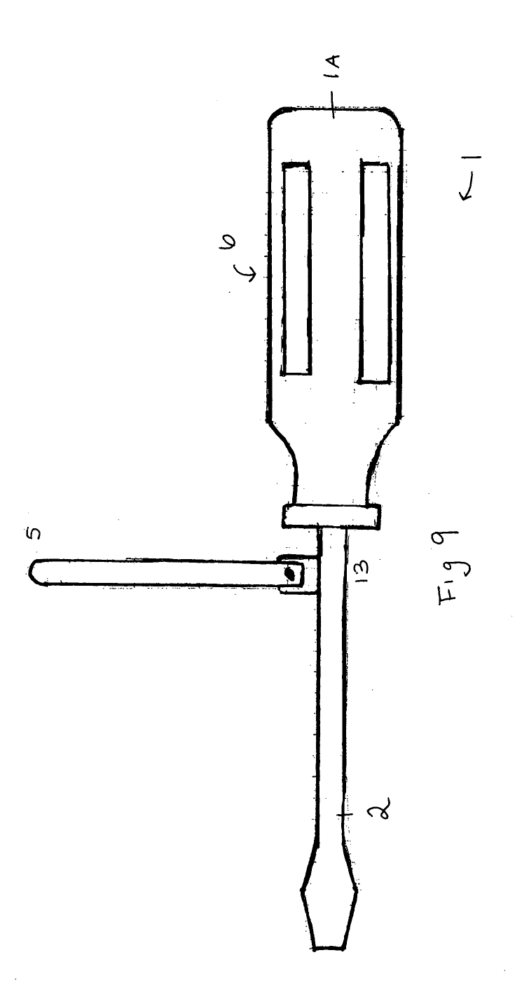

FIG. 8 is a side perspective of the present invention illustrating the plastic or metal handle 5 in the extended position ready to be used along with the screwdriver 2. Also, this embodiment makes use of a clamp or u-bolt 9 attachment means to secure the lever 5 to the driver 1. The u-bolt 9 is secured by nuts 11 and the lever 5 is attached by a hinge 10. The plastic or metal lever 5 also fits into the recess groove 6 in the screwdriver handle 1A.

FIG. 8A is detailed view of the clamp or u-bolt 9. In this side perspective the lever 5 is at a 90° angle and is attached to the flat piece with an attached hinge 12. The u-bolt or clamp 9 is secured with nuts 11.

FIG. 9 is is a side perspective of the present invention illustrating the plastic or metal handle 5 in the extended position ready to be used along with the screwdriver 2. Also, this embodiment makes use of a welded tab 13 attached to the screwdriver 2 by a hinged pin joint 14. The lever 5 is shown in the open position, there is also a recessed groove 6 for the handle to fit into.

It is contemplated that the present invention can be manufactured out of any conventional materials used in the art. As illustrated in the pictures the modification can be made permanent by incorporating a joint from which the plastic or metal lever can pivot or turn, or the modification can be made a temporary fixture that can be attached to the screwdriver handle 1A by screwing in to the handle or sliding over the screwdriver handle.

It should also be appreciated that the present invention should not be limited to just screwdrivers, but can be versatile enough to attach to most any hand-held tool, such as wrenches, nut drivers, sockets, Philips head screwdriver, regular screwdriver torx driver and other hand-held tools.

Although the lever 5 is shown attached to a projection extending from the head of the driver, other arrangements are possible, For example, there may be an adjustable ring that can be secured around the head of the driver. Extending from an outer surface of the ring there is a first pivot member and a second pivot member. The first and second pivot members are separated from each other and are provided with an orifice for receiving a pin. The arm is positioned between the first and second pivot members and a pin extends from one pivot member through an orifice in the arm to the other pivot member. Alternatively, the lever can be secured to the stem by means of first and second projections that extend from the stem and which can be used to secure the arm to the stem by means of a pin that passes through the projection and the pin as shown above. Similarly, the arm may be secured to the stem by means of an adjustable ring.

In addition the present invention has been described with a certain degree of particularity; however changes may be made in the details of construction and arrangement of components without departing form the scope of this disclosure.

We claim:

1. A driver comprising a shaft said shaft having a first end and a second end said shaft having a handle at said first end and a driving means at said second end said driver having a lever hingedly attached to said driver so that said lever is adapted to extend from stored position to an operating position.

2. A driver according to claim 1 in which said lever is adapted to be stored in a recess in said handle.

3. A driver according to claim 1 in which said lever is adjacent said handle in stored position.

4. A driver according to claim 1 in which said lever is hingedly attached to said shaft

5. A driver according to claim 1 in which a hinge is attached to where said shaft meets said handle.

6. A driver according to claim 1 in which said lever is hingedly attached to said handle

7. A driver according to claim 1 in which said lever is hingedly connected to a exterior surface of a ring that is removably attached to said handle

8. A driver according to claim 1 in which the lever is hingedly attached to said drawing by means of a pin and a first and a second connecting means so that said pin goes from first connecting means through an orifice in said lever to said second connecting means.

9. A driver according to claim 1 in which said lever having a first end and a second end is circular in cross-section.

10. A driver according to claim 1 in which said lever has a first end and a second end with said first end having a opposing sides with an orifice in each said opposing side and said lever having an curved shape so that said lever mates with the exterior surface of said handle and does not protrude from a side of said handle.

11. A driver according to claim 1 in which said handle retains said lever in a stored position contains a magnet.

12. A driver according to claim 1 in which said lever is attached to said handle by a pivot joint with said pivot joint having a first and second connecting means so that a pin goes from first connecting means though an orifice in said lever and connects through another orifice in said second connecting means.

13. A driver according to claim 13 in which said lever is attached to said shaft.

14. A driver according to claim 1 in which said lever is attached to said handle by a ball joint said ball joint having a housing means said housing means having a first end and a second end, said first end being attached to said handle and said second end having an opening to receive a ball so that said ball can rotate inside said housing means said lever being connected to said ball.

15. A driver according to claim 14 in which said first end is removably attached to said handle.

16. A driver according to claim 14 in which said housing means has a connecting means in the form of a u-bolt with a first end and a second end so that said u-bolt connects said housing means through an orifices in said housing means and is fastened by a nut on said first end of u-bolt and said second end of u-bolt.

17. A driver according to claim 1, in which said driver is a ratchet.

18. A driver according to claim 1, in which said driver is a wrench.

19. A driver according to claim 1, in which said driver is a socket.

20. A driver according to claim 1 in which said driver is a philips head screwdriver

21. A driver according to claim 1 in which said driver is a slotted screwdriver.

22. A driver according to claim 1 in which said driver is a torx driver.
